(19) United States
(12) Patent Application Publication
(10) Pub. No.: US 2015/0088958 A1
(43) Pub. Date: Mar. 26, 2015

(54) Information Processing System and Distributed Processing Method

(71) Applicant: NEC Corporation, Tokyo (JP)

(72) Inventor: Junichi YASUDA, Tokyo (JP)

(73) Assignee: NEC Corporation, Tokyo (JP)

(21) Appl. No.: 14/490,227

(22) Filed: Sep. 18, 2014

(30) Foreign Application Priority Data
Sep. 24, 2013 (JP) 2013-196635

(51) Int. Cl. H04L 29/08

(52) U.S. Cl. CPC H04L 67/10
USPC 709/201

(57) ABSTRACT

In a system of performing distributed processing on a plurality of data segments at a plurality of nodes, the processing load on the system is reduced. A distributed processing system 1 includes nodes 200. Each of the nodes 200 includes a data segment sending unit 220 and a processing unit 230. The data segment sending unit 220 sends a data segment 510 being a processing target of the node 200 among a plurality of data segments 510, to another node 200 having a possibility of using the data segment 510 as a related data segment. The processing unit 230 performs a predetermined process on the data segment 510 by using the data segment 510 and a related data segment, of the data segment 510, which is received from another node 200.

This application is based upon and claims the benefit of priority from Japanese Patent Application No. 2013-196635, filed on Sep. 24, 2013, the disclosure of which is incorporated herein in its entirety by reference.

### TECHNICAL FIELD

The present invention relates to an information processing system and a distributed processing method, and in particular, to an information processing system and a distributed processing method in which distributed processing is performed on data divided into data segments at a plurality of nodes.

### BACKGROUND ART

In association with improvement in performance of computer hardware and software and also of networks, a technology for achieving high processing performance by connecting a plurality of computers via a network and thereby performing distributed processing has been developed.

Particularly in recent years, in association with advances in distributed processing technology, a distributed parallel processing platform enabling high-speed analysis of mass amounts of data has been provided and applied to derivation of a tendency or knowledge about mass amounts of data. For example, Hadoop, which is well known as a distributed parallel processing platform, has been applied to mining of a customer's information or behavior history and to trend analysis from mass amounts of log information.

A technology for importing mass amounts of data into a distributed parallel processing platform is disclosed, for example, in “Apache Sqoop”, The Apache Software Foundation, [online], [retrieved on Aug. 13, 2013], on the internet <URL:http://sqoop.apache.org/>. In such a technology, one method of importing mass amounts of data at high speed is the method in which writing into a distributed storage system is performed in parallel at a plurality of nodes. FIG. 16 is a diagram showing an example of a method of importing mass amounts of data into a distributed parallel processing platform. In the example of FIG. 16, a data server extracts data segments from original data including mass amounts of data and sends them to a plurality of nodes in the distributed parallel processing platform. Here, the data server detects a delimiter of records or the like in the original data using, for example, a technology such as “RFC4180 Common Format and MIME Type for Comma-Separated Values (CSV) Files”, Y. Shafranovich, [online] [retrieved on Aug. 13, 2013], on the internet <URL: http://tools.ietf.org/html/rfc4180>, and thereby extracts each data segment. The nodes perform processing of the respective data segments (for example, format check, format transformation and the like), a process of writing them into a distributed storage system and the like, in parallel with each other.

In an import process into the above-mentioned distributed parallel processing platform shown in FIG. 16, if there are correlations between the data segments, there may be a case where each of the nodes needs, at a time of its processing of a data segment, also another data segment (related data segment) being a processing target of another node. In that case, each of the nodes needs to search for another node holding a related data segment and then acquire the related data segment from the another node. In particular, when the number of data segments or of nodes is large, there is an increase in the system load associated with such searching for another node and replication and forwarding of a related data segment.

### SUMMARY

An exemplary object of the present invention is to solve the problem described above and consequently provide an information processing system and a distributed processing method which, in a system of performing distributed processing on a plurality of data segments at a plurality of nodes, reduce the processing load on the system.

An information processing system according to an exemplary aspect of the invention includes processing devices, the processing devices each including: a sending unit which sends a data segment being a processing target of the processing device among a plurality of data segments, to another processing device having a possibility of using the data segment as a related data segment; and a processing unit which performs a predetermined process on the data segment by using the data segment and a related data segment, of the data segment, which is received from another processing device.

A distributed processing method for information processing system including processing devices according to an exemplary aspect of the invention includes: sending a data segment being a processing target of the processing device among a plurality of data segments, to another processing device having a possibility of using the data segment as a related data segment, in each of the processing devices; and performing a predetermined process on the data segment by using the data segment and a related data segment, of the data segment, which is received from another processing device, in each of the processing devices.

A non-transitory computer readable storage medium recording thereon a program, according to an exemplary aspect of the invention, causes a computer for each of the processing devices to function as: a sending unit which sends a data segment being a processing target of the processing device among a plurality of data segments, to another processing device having a possibility of using the data segment as a related data segment; and a processing unit which performs a predetermined process on the data segment by using the data segment and a related data segment, of the data segment, which is received from another processing device.

### BRIEF DESCRIPTION OF THE DRAWINGS

Exemplary features and advantages of the present invention will become apparent from the following detailed description when taken with the accompanying drawings in which:

FIG. 1 is a block diagram showing a characteristic configuration of a first exemplary embodiment of the present invention.

FIG. 2 is a block diagram showing a configuration of a distributed processing system 1 in the first exemplary embodiment of the present invention.

FIG. 3 is a block diagram showing a configuration of the distributed processing system 1 wherein a data server 100 and nodes 200 are each realized by a computer, in the first exemplary embodiment of the present invention.

FIG. 4 is a flow chart showing a process of importing original data 500, in the first exemplary embodiment of the present invention.

FIG. 5 is a diagram showing import of the original data 500 into a distributed parallel processing platform, in the first exemplary embodiment of the present invention.

FIG. 6 is a diagram showing an example of the original data 500, data segments 510 and pieces of metadata 520, in the first exemplary embodiment of the present invention.

FIG. 7 is a diagram showing an example of server setting information 161 in the first exemplary embodiment of the present invention.

FIG. 8 is a diagram showing an example of a forwarding plan 131 in the first exemplary embodiment of the present invention.

FIG. 9 is a diagram showing an example of node setting information 251 in the first exemplary embodiment of the present invention.

FIG. 10 is a diagram showing an example of extraction and processing of target information in the first exemplary embodiment of the present invention.

FIG. 11 is a diagram showing import of original data 500 into a distributed parallel processing platform, in a second exemplary embodiment of the present invention.

FIG. 12 is a diagram showing an example of extraction and processing of target information, in the second exemplary embodiment of the present invention.

FIG. 13 is a block diagram showing a configuration of a distributed processing system 1 in a third exemplary embodiment of the present invention.

FIG. 14 is a flow chart showing a handover process in the third exemplary embodiment of the present invention.

FIG. 15 is a diagram showing an example of extraction and processing of target information in the handover process, in the third exemplary embodiment of the present invention.

FIG. 16 is a diagram showing an example of a method of importing mass amounts of data into a distributed parallel processing platform.

### EXEMPLARY EMBODIMENT

### First Exemplary Embodiment

A first exemplary embodiment of the present invention will be described below.

First, a description will be given of import of original data 500 into a distributed parallel processing platform, in the first exemplary embodiment of the present invention.

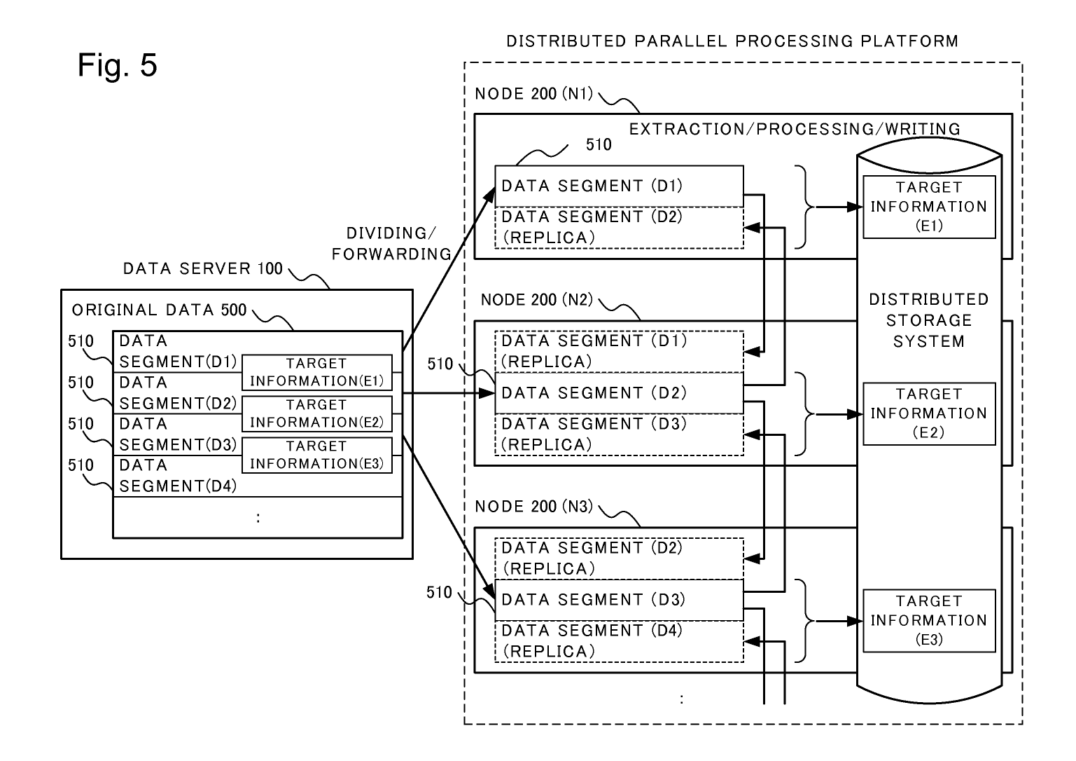

FIG. 5 is a diagram showing import of original data 500 into a distributed parallel processing platform in the first exemplary embodiment of the present invention.

In the first exemplary embodiment of the present invention, the original data 500 stored in a data server 100 is, for example, a database or a log file, and it includes a plurality of pieces of target information. Here, the target information is a unit of processing, such as one record in a database or one log record in a log file, in terms of which mining or analysis is performed.

The data server 100 divides the original data 500 into data segments (may be alternatively referred to simply as pieces of data) 510 each having a predetermined length, and sends them to a plurality of nodes 200. Then, each of the nodes 200 performs predetermined processes on a data segment 510 received from the data server 100 (a data segment 510 being a processing target of the node 200), such as extraction of target information, format check, format transformation and writing into a distributed storage system built on the plurality of nodes 200.

When the data segment 510 being its processing target includes only part of target information to be extracted, the node 200 performs extraction of the target information by the use of a replica (copy) of another data segment 510 (an adjacent data segment) which is immediately adjacent to the data segment 510 being the processing target. In the first exemplary embodiment of the present invention, a replica of an adjacent data segment of a data segment 510 will be referred to as a related data segment of the data segment 510. When having received a data segment 510 from the data server 100, each of the nodes 200 generates a replica of the data segment 510 into another node 200 which is to use the data segment 510 as a related data segment (another node 200 to use an adjacent data segment of the data segment 510 as its processing target).

Next, a description will be given of a configuration of a distributed processing system 1 in the first exemplary embodiment of the present invention.

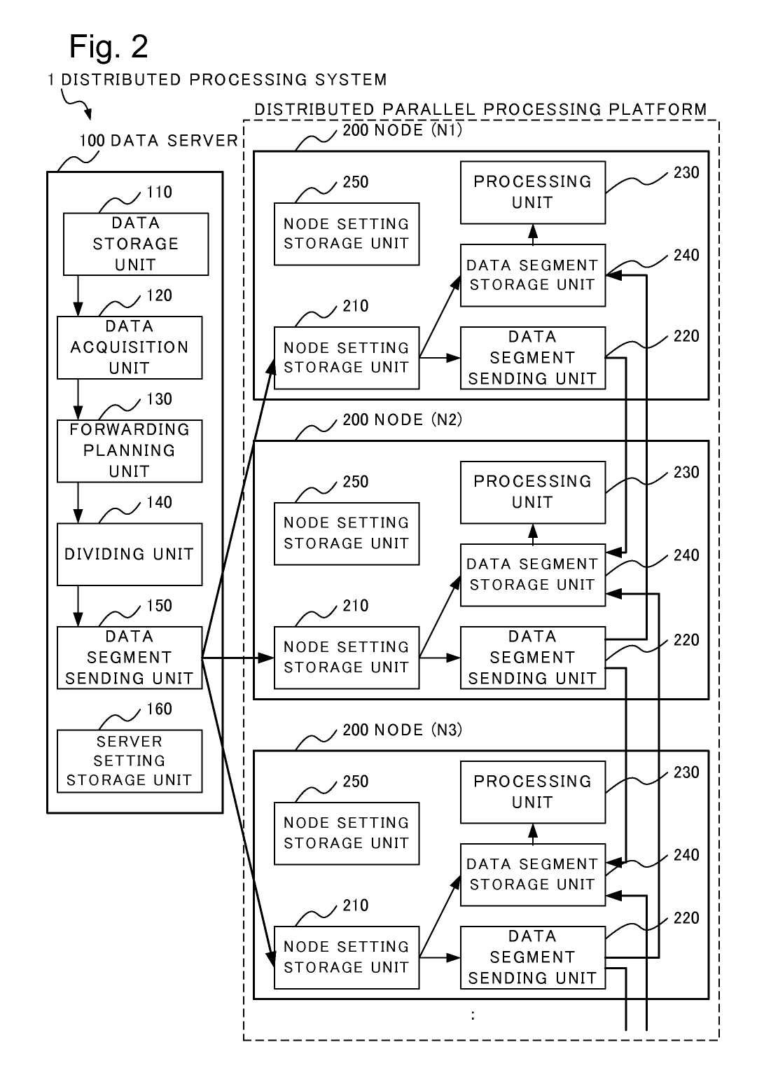

FIG. 2 is a block diagram showing a configuration of a distributed processing system 1 in the first exemplary embodiment of the present invention. Referring to FIG. 2, the distributed processing system 1 in the first exemplary embodiment of the present invention includes a data server (or, a control device) 100 and a plurality of nodes (or, processing devices) 200 in a distributed parallel processing platform.

The distributed processing system 1 is one exemplary embodiment of an information processing system of the present invention.

The data server 100 and the plurality of nodes 200 are connected via a network or the like in a manner to enable them to communicate with each other. In the example in FIG. 2, the data server 100 and the nodes 200 “N1”, “N2”, . . . are connected with each other. Here, the signs between double quotation marks represent an identifier of the node 200. Hereafter, the same kind of expression will be used for another identifier to be described later.

The data server 100 includes a data storage unit 110, a data acquisition unit 120, a forwarding planning unit 130, a dividing unit 140, a data segment sending unit 150 and a server setting storage unit 160.

The data storage unit 110 stores the original data 500.

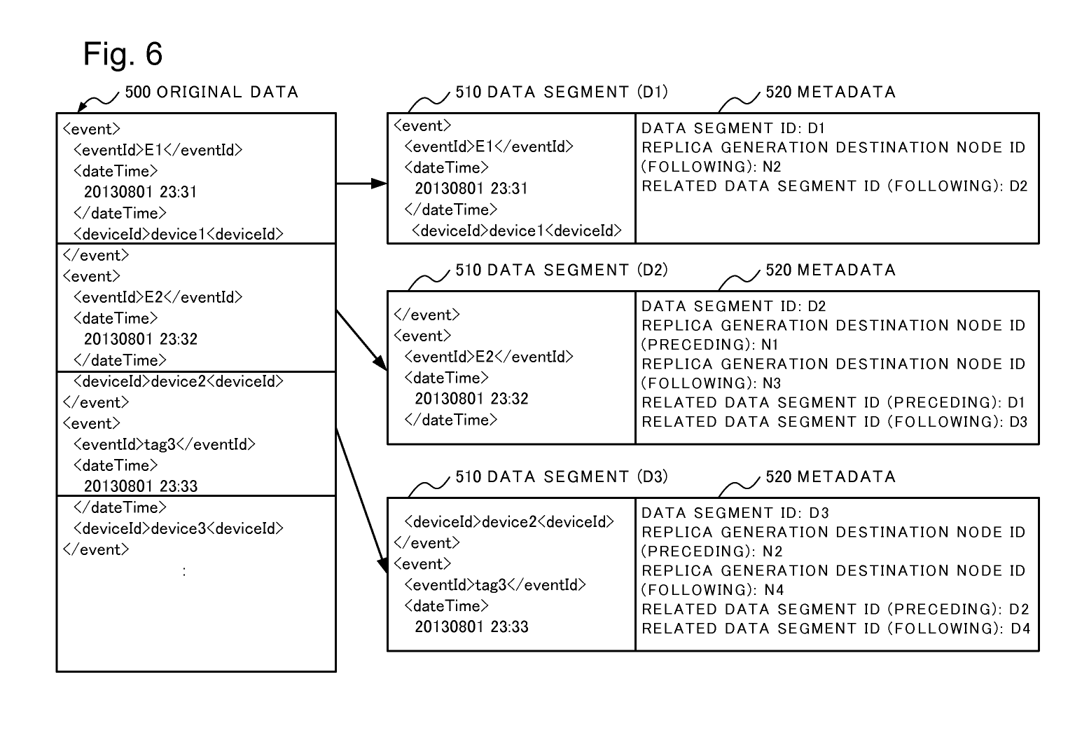

FIG. 6 is a diagram showing an example of original data 500, data segments 510 and pieces of metadata 520, in the first exemplary embodiment of the present invention.

In the first exemplary embodiment of the present invention, the data format of the original data 500 is the XML (eXtensible Markup Language) format, as shown in FIG. 6. The original data 500 includes event information identified by an event identifier (event ID), as target information. Each piece of target information is extracted according to delimiters <event> and </event> representing a start point and an end point, respectively.

The data acquisition unit 120 acquires the original data 500 from the data storage unit 110.

The server setting storage unit 160 stores server setting information 161, which is information about a process performed by the data server 100. The server setting information 161 is set in advance by an administrator or the like, for example.

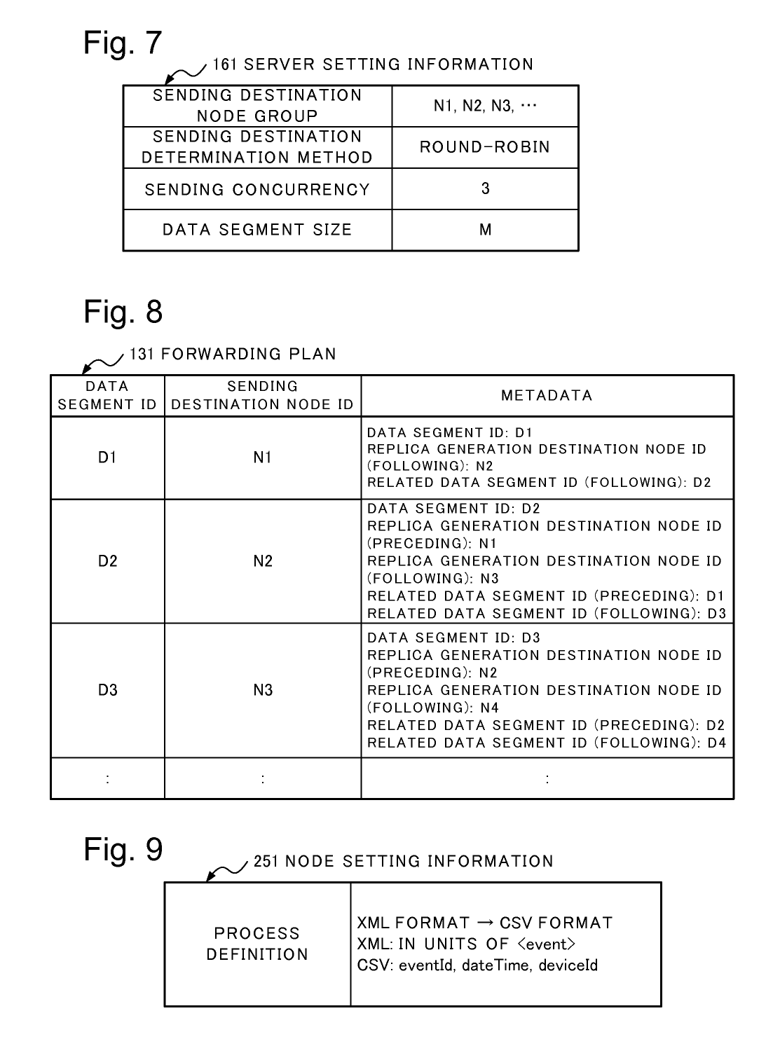

FIG. 7 is a diagram showing an example of the server setting information 161 in the first exemplary embodiment of the present invention. In the example shown in FIG. 7, the server setting information 161 includes a sending destination node group, a sending destination determination method, a sending concurrency and a data segment size.

Here, the sending destination node group designates the identifiers of nodes 200 being candidates for destinations for sending of the data segments 510. The sending destination determination method designates a method of determining a destination for sending of a data segment 510, from among the nodes 200 included in the sending destination node group. The sending concurrency designates the number of data segments 510 able to be sent in parallel, with no need of waiting for confirmation of their arrival. The data segment size designates the size of each data segment 510.

In accordance with the server setting information 161, the forwarding planning unit 130 generates a forwarding plan 131, which is information about sending of the data segments 510 to the nodes 200.

FIG. 8 is a diagram showing an example of the forwarding plan 131 in the first exemplary embodiment of the present invention. In the example shown in FIG. 8, the forwarding plan 131 includes a sending destination node ID and metadata (or, information on related devices) 520, for each data segment ID.

Here, the data segment ID represents the identifier of a data segment 510. The sending destination node ID represents the identifier of a node 200 being a destination for sending of the data segment 510.

The metadata 520 is information to be sent along with the related data segment 510 to the designated destination node 200. The metadata 520 includes a data segment ID, replica generation destination node IDs (preceding or following) and related data segment IDs (preceding or following). The replica generation destination node IDs (preceding or following) designate the identifiers of nodes 200 each being a destination for generation (sending) of a replica of the data segment 510. The replica generation destination node ID (preceding) is equal to the identifier of a node 200 which uses as its processing target the preceding-side adjacent data segment of the data segment 510. The replica generation destination node ID (following) is equal to the identifier of a node 200 which uses as its processing target the following-side adjacent data segment of the data segment 510. The related data segment ID (preceding) designates the identifier of the preceding-side adjacent data segment of the data segment 510. The related data segment ID (following) designates the identifier of the following-side adjacent data segment of the data segment 510.

In accordance with the forwarding plan 131, the dividing unit 140 divides the original data 500 into the data segments 510.

Also in accordance with the forwarding plan 131, the data segment sending unit 150 sends the data segments 510 and the pieces of metadata 520 associated with them to the respective nodes 200. The data segment sending unit 150 may perform confirmation of arrival of a data segment 510 with a node 200, by receiving an ACK with respect to the data segment 510 from the node 200.

Each of the nodes 200 includes a data segment reception unit 210, a data segment sending unit (or simply, a sending unit) 220, a processing unit 230, a data segment storage unit 240 and a node setting storage unit 250.

The data segment reception unit 210 receives a data segment 510 and metadata 520 from the data server 100. The data segment reception unit 210 may perform confirmation of arrival of the data segment 510 with the data server 100, by sending the data server 100 an ACK with respect to the data segment 510. In that case, the data segment reception unit 210 sends back an ACK to the data server 100 at a time a replica of the data segment 510 has been generated into other nodes 200.

When the data segment 510 has been received from the data server 100, the data segment sending unit 220 generates a replica of the data segment 510 into the other nodes 200 according to the metadata 520. In the first exemplary embodiment of the present invention, it is assumed that writing into the data segment storage unit 240 of each of the nodes 200 is possible also from another node 200. The data segment sending unit 220 generates the replica by writing the data segment 510 into the data segment storage unit 240 of each of the nodes 200 designated by the replica generation destination node IDs (preceding and following) in the metadata 520.

Here, the replica may be generated by an alternative way in which the data segment sending unit 220 sends the data segment 510 to a related data segment reception unit (not illustrated) of each of the nodes 200 designated by the replica generation destination node IDs (preceding and following) and the related data segment reception unit writes the data segment 510 into the data segment storage unit 240 in the same node 200.

The node setting storage unit 250 stores node setting information 251, which is information about a process performed by the node 200. The node setting information 251 is set in advance by an administrator or the like, for example.

FIG. 9 is a diagram showing an example of the node setting information 251 in the first exemplary embodiment of the present invention. The node setting information 251 includes a process definition.

Here, the process definition represents the process content of processing (format check, format transformation or the like) to be performed on extracted target information. In the example shown in FIG. 9, transformation from the XML format into the CSV format is defined in the process definition.

The data segment storage unit 240 stores the data segment 510 and the metadata 520, which have been received by the data segment reception unit 210 from the data server 100, and data segments 510 generated by other nodes 200.

According to the metadata 520 and the node setting information 251, the processing unit 230 performs predetermined processes (extraction of target information, and its processing and writing into the distributed storage system) on the data segment 510 received from the data server 100. If only part of the target information to be extracted is included in the data segment 510, the processing unit 230 extracts the target information from the data segment 510 and from the replica(s) of adjacent data segment(s) of the data segment 510.

Here, each of the data server 100 and the nodes 200 may be a computer which includes a CPU (Central Processing Unit) and a recording medium storing a program and operates under the control based on the program. In the data server 100, the data storage unit 110 and the server setting storage unit 160 may be constituted either by different recording media (for example, memories, hard disks and the like) or by a common recording medium. Similarly, in each of the nodes 200, the data segment storage unit 240 and the node setting storage unit 250 may be constituted either by different recording media (for example, memories, hard disks and the like) or by a common recording medium.

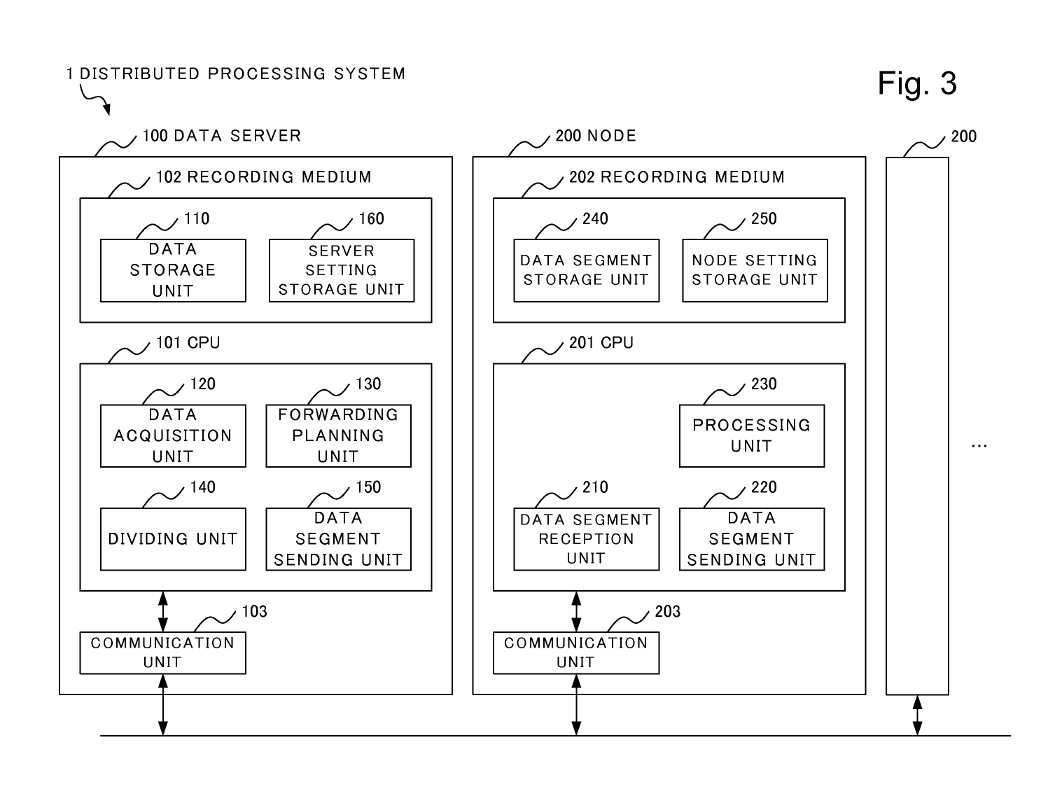

FIG. 3 is a block diagram showing a configuration of the distributed processing system 1, where the data server 100 and the nodes 200 are each realized by a computer, in the first exemplary embodiment of the present invention.

Referring to FIG. 3, the data server 100 includes a CPU 101, a recording medium 102 and a communication unit 103. The CPU 101 executes a computer program for realizing the functions of the data acquisition unit 120, the forwarding planning unit 130, the dividing unit 140 and the data segment sending unit 150. The recording medium 102 stores data to be stored in the data storage unit 110 and that to be stored in the server setting storage unit 160. The communication unit 103 sends the data segments 510 to the nodes 200.

Each of the nodes 200 includes a CPU 201, a recording medium 202 and a communication unit 203. The CPU 201 executes a computer program for realizing the functions of the data segment reception unit 210, the data segment sending unit 220 and the processing unit 230. The recording medium 202 stores data to be stored in the data segment storage unit 240 and that to be stored in the node setting storage unit 250. The communication unit 203 receives a data segment 510 from the data server 100. The communication unit 203 may receive a replica of an adjacent data segment from another node 200 and send a replica of the data segment 510 received from the data server 100 to another node 200.

Next, operation of the first exemplary embodiment of the present invention will be described.

Here, it is assumed that the server setting information 161 in FIG. 7 and the node setting information 251 in FIG. 9 are stored in, respectively, the server setting storage unit 160 and the node setting storage unit 250.

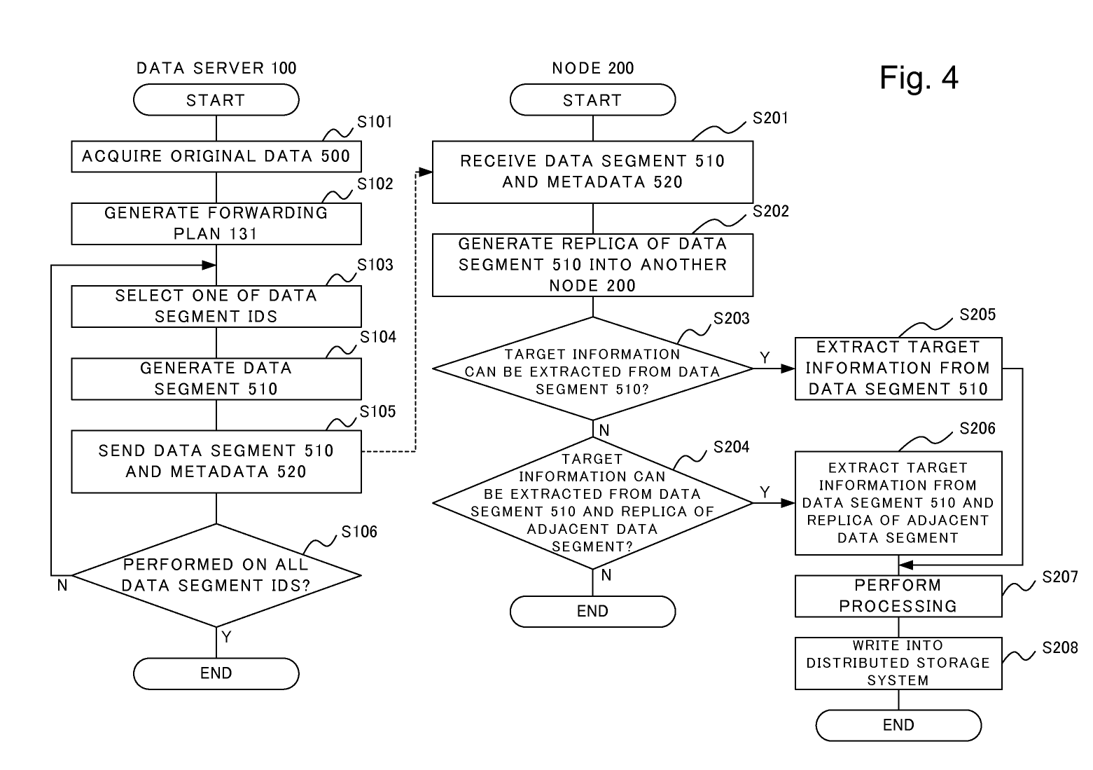

FIG. 4 is a flow chart showing a process of importing original data 500, in the first exemplary embodiment of the present invention.

First, the data acquisition unit 120 of the data server 100 acquires original data 500 from the data storage unit 110 (step S101).

For example, the data acquisition section 120 acquires the original data 500 shown in FIG. 6.

Next, the forwarding planning unit 130 generates a forwarding plan 131 (step S102). Here, the forwarding planning unit 130 divides the original data 500 into data segments 510 of a size equal to the data segment size defined in the server setting information 161, and gives a data segment ID to each of the data segments 510. Then, according to the destination determination method defined in the server setting information 161, the forwarding planning unit 130 determines destination nodes for sending of respective ones of the data segments 510, from among the nodes 200 included in the destination node group also defined in the server setting information 161. Further, for the replica generation destination node ID (preceding) in metadata 520 to be associated with each of the data segments 510, the forwarding planning unit 130 sets the identifier of another node 200 which uses a replica of the data segment 510 as the related data segment (following) (in other words, a node 200 which uses the preceding-side adjacent data segment of the data segment 510 as its processing target). Also, for the replica generation destination node ID (following) in metadata 520 to be associated with each of the data segments 510, the forwarding planning unit 130 sets the identifier of another node 200 which uses a replica of the data segment 510 as the related data segment (preceding) (in other words, a node 200 which uses the following-side adjacent data segment of the data segment 510 as its processing target).

For example, as shown in FIG. 8, the forwarding planning unit 130 gives data segment IDs “D1”, “D2”, . . . to respective ones of the data segments 510 into which the original data 500 in FIG. 6 has been divided according to the data segment size defined in the server setting information 161 shown in FIG. 7. Also as shown in FIG. 8, the forwarding planning unit 130 determines the destinations for sending of the data segments 510 “D1”, “D2”, . . . to be respectively the nodes 200 “N1”, “N2”, . . . , according to the destination determination method (round-robin) defined in the setting information 161 in FIG. 7. Also as shown in FIG. 8, in the metadata 520 to be associated with the data segment 510 “D1”, the forwarding planning unit 130 sets the node 200 “N2”, which uses a replica of the data segment 510 “D1” (in other words, which uses the adjacent data segment “D2” as its processing target), for the replica generation destination node ID (following), and sets the following-side adjacent data segment “D2” for the related data segment (following). Further, in the metadata 520 to be associated with the data segment 510 “D2”, the forwarding planning unit 130 sets the node 200 “N1”, which uses a replica of the data segment 510 “D2” (in other words, which uses the adjacent data segment “D1” as its processing target), for the replica generation destination node ID (preceding), and sets the node 200 “N3”, which also uses a replica of the data segment 510 “D2” (in other words, which uses the adjacent data segment “D3” as its processing target), for the replica generation destination node ID (following), and further sets the preceding-side adjacent data segment “D1” for the related data segment (preceding), and the following-side adjacent data segment “D3” for the related data segment (following).

The dividing unit 140 selects one of the data segment IDs included in the forwarding plan 131 sequentially from the top (step S103).

The dividing unit 140 generates a data segment 510 corresponding to the data segment ID selected from the original data 500 (step S104).

The data segment sending unit 150 sends the generated data segment 510 and metadata 520 included in the forwarding plan 131 in a manner to be associated with the data segment 510, to a node 200 corresponding to the destination node ID associated with the data segment 510 in the forwarding plan 131 (step S105). When it has received from the node 200 an ACK with respect to the data segment 510 thus sent, the data segment sending unit 150 determines the data segment 510 to be an already-sent one.

The dividing unit 140 and the data segment sending unit 150 repeat the steps from S103 to S105 with respect to all data segment IDs included in the forwarding plan 131 (step S106).

Here, in accordance with the sending concurrency included in the server setting information 161, the dividing unit 140 and the data segment sending unit 150 may execute the steps from S103 to S105 on a plurality of data segments 510 in parallel, without waiting for confirmation of their arrival.

For example, as the sending concurrency included in the server setting information 161 in FIG. 7 is 3, the dividing unit 140 generates, on the basis of the forwarding plan 131 in FIG. 8, the data segments 510 “D1”, “D2” and “D3” from the original data 500, as shown in FIG. 6. Then, also as shown in FIG. 6, the data segment sending unit 150 attaches to each of the data segments 510 “D1”, “D2” and “D3” the associated metadata 520 in the forwarding plan 131 shown in FIG. 8, and then sends them to the nodes 200 “N1”, “N2” and “N3”, respectively.

Next, in each of the nodes 200 described above, the data segment reception unit 210 receives the data segment 510 and the metadata 520 from the data server 100 (step S201). The data segment reception unit 210 stores the received data segment 510 and metadata 520 into the data segment storage unit 240.

For example, the data segment reception units 210 of the respective nodes 200 “N1”, “N2” and “N3” receive the data segments 510 “D1”, “D2” and “D3” and the associated pieces of metadata 520 shown in FIG. 6, respectively.

In each node 200, the data segment sending unit 220 generates a replica of the received data segment 510 into the data segment storage unit 240 of each of the nodes 200 designated by the replica generation destination node IDs (preceding and following) in the received metadata 520 (step S202). At a time the replicas of the data segment 510 have been generated into the other nodes 200, the data segment reception unit 210 sends back an ACK with respect to the data segment 510 to the data server 100.

For example, according to the metadata 520 associated with the data segment 510 “D1” in FIG. 6, the data segment sending unit 220 of the node 200 “N1” generates a replica of the data segment 510 “D1” into the node 200 “N2”, as shown in FIG. 5. Similarly, the data segment sending unit 220 of the node 200 “N2” generates a replica of the data segment 510 “D2” into each of the nodes 200 “N1” and “N3”.

Next, the processing unit 230 acquires the data segment 510 from the data segment storage unit 240, and then determines whether target information can be extracted from the data segment 510 or not (step S203). Here, the processing unit 230 determines whether target information can be extracted or not by detecting delimiters representing start and end points of the target information. If both the delimiter representing the start point and the delimiter representing the end point paired with the start point are included in the data segment 510, the processing unit 230 determines that target information can be extracted. If the delimiter representing the start point is included but the delimiter representing the end point paired with the start point is not, in the data segment 510, the processing unit 230 determines that target information cannot be extracted.

When extraction of target information has been determined to be possible in the step S203 (Y at the step S203), the processing unit 230 extracts target information from the data segment 510 (step S205).

When extraction of target information has been determined to be impossible in the step S203 (N at the step S203), the processing unit 230 acquires, from the data segment storage unit 240, the replica of the following-side adjacent data segment of the data segment 510, which is designated by the related data segment ID (following) in the metadata 520.

Then, the processing unit 230 determines whether or not target information can be extracted from the data segment 510 and the replica of the adjacent data segment (step S204). Here, if the replica of the adjacent data segment includes the delimiter representing the end point paired with the start point included in the data segment 510, the processing unit 230 determines that target information can be extracted.

When extraction of target information has been determined to be possible in the step S204 (Y at the step S204), the processing unit 230 extracts target information from the data segment 510 and from the replica of the adjacent data segment (step S206).

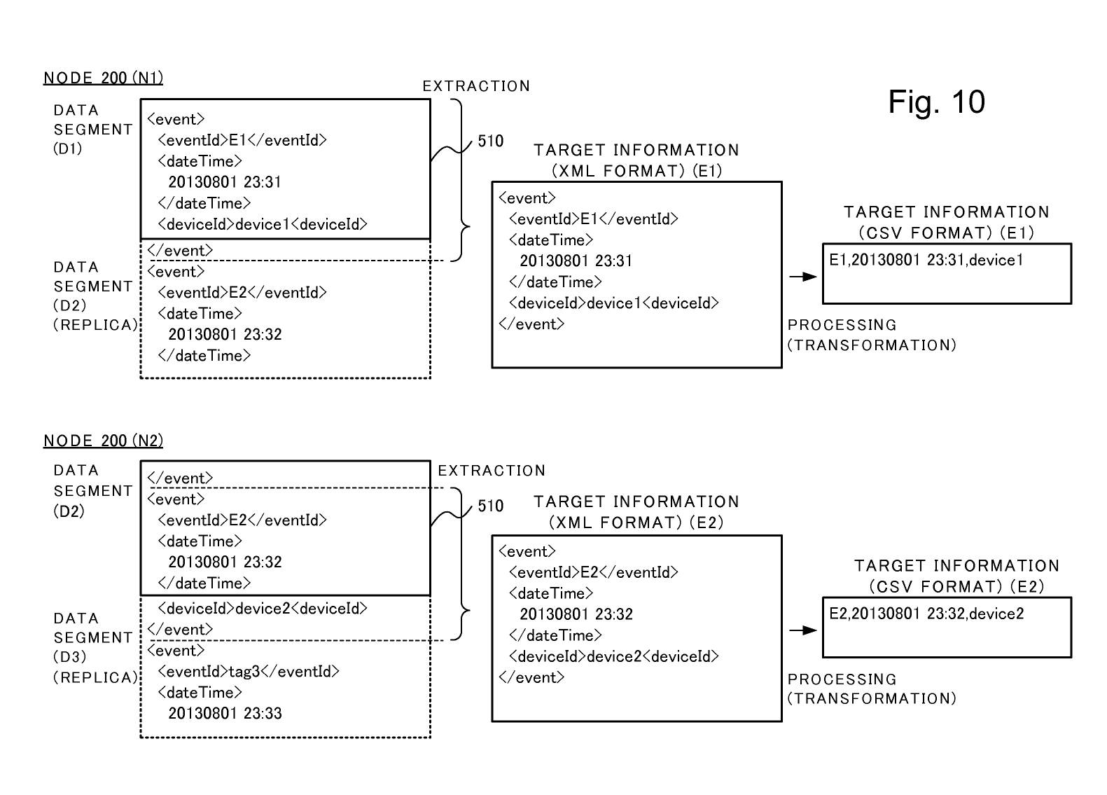

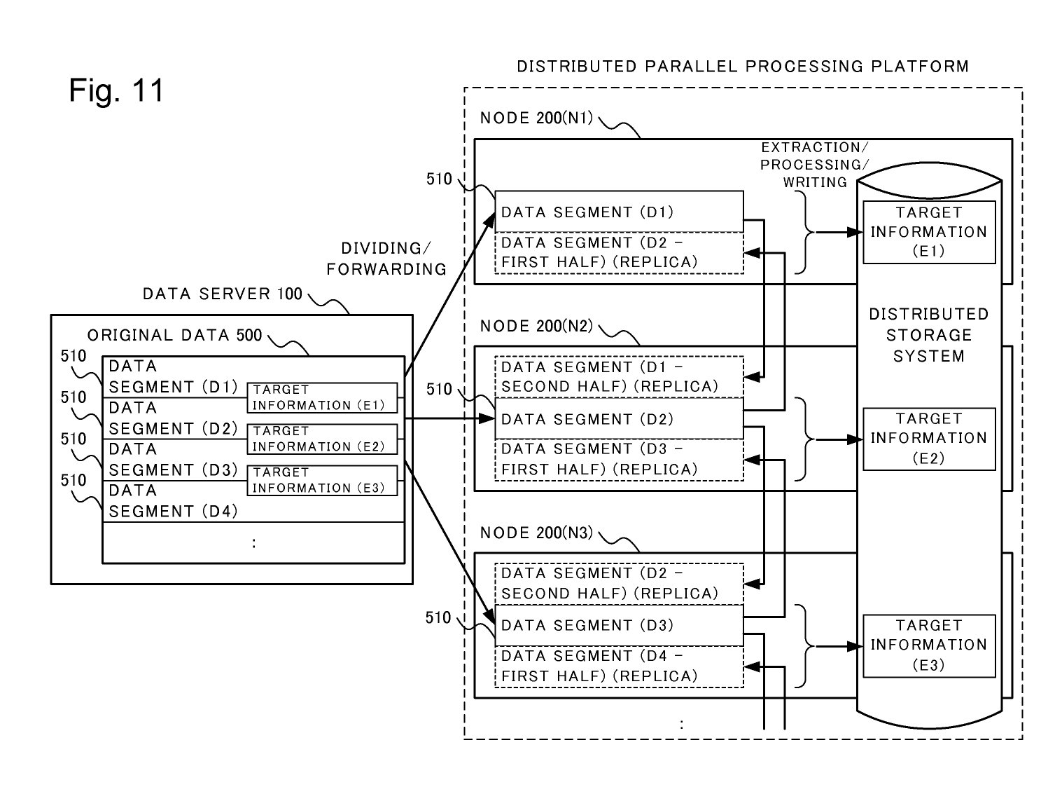

FIG. 10 is a diagram showing an example of extraction and processing of target information, in the first exemplary embodiment of the present invention.

For example, as shown in FIG. 10, in the node 200 “N1”, the data segment 510 “D1” includes the delimiter <event> representing the start point of event information “E1”, but not the delimiter </event> representing the end point. The delimiter </event> representing the end point is included in the replica of the adjacent data segment “D2”. Accordingly, the processing unit 230 of the node 200 “N1” extracts the event information “E1” from the data segment 510 “D1” and from the replica of the adjacent data segment “D2”, as shown in FIG. 10.

Similarly, in the node 200 “N2”, as shown in FIG. 10, the data segment 510 “D2” includes the delimiter <event> representing the start point of event information “E2”, but not the delimiter </event> representing the end point. The delimiter </event> representing the end point is included in the replica of the adjacent data segment “D3”. Accordingly, the processing unit 230 of the node 200 “N2” extracts the event information “E2” from the data segment 510 “D2” and from the replica of the adjacent data segment “D3”, as shown in FIG. 10.

Then, on the extracted target information, the processing unit 230 performs processing designated by the process definition in the node setting information 251 (step S207).

For example, as shown in FIG. 10, the respective processing units 230 of the nodes 200 “N1” and “N2” transform the event information “E1” and the event information “E2”, respectively, from the XML format into the CSV format, according to the process definition in the node setting information 251 shown in FIG. 9.

Then, the processing unit 230 writes the processed target information into the distributed storage system (step S208).

For example, the respective processing units 230 of the nodes 200 “N1” and “N2” writes, respectively, the event information “E1” and the event information “E2”, both in the CSV format and shown in FIG. 10, into the distributed storage system.

With that step, the operation of the first exemplary embodiment of the present invention is completed.

In the first exemplary embodiment of the present invention, the processing unit 230 extracts target information for which the delimiter representing its start point is included in the data segment 510. However, the processing unit 230 may extract target information for which the delimiter representing its end point is included in the data segment 510. In that case, if the data segment 510 does not include the delimiter representing the start point paired with the end point, the processing unit 230 extracts target information using the data segment 510 and the replica of the preceding-side adjacent data segment.

At a time, for example, when the predetermined process has been completed on all of the data segments 510 at the plurality of nodes 200, the processing unit 230 of each of the nodes 200 may eliminate the data segment 510 and the adjacent data segments stored in the data segment storage unit 240.

As the data format of the original data 500, the XML format is used in the first exemplary embodiment of the present invention, but the data format may also be other than the XML format, such as the CSV (comma-separated values) format, the JSON (Java (registered trademark) Script Object Notation) format and a log file. When the data format is the JSON format, tags enclosing target information can be used, similarly to the case of the XML format, as delimiters representing the start and end points of the target information. When the data format is the CSV format or a log file, a line feed code or the date and time can be used, respectively, as delimiters representing the start and end points of target information.

In the first exemplary embodiment of the present invention, each node 200 performs extraction of target information and its processing and writing into the distributed storage system, as predetermined processes on the data segment 510, but the writing into the distributed storage system does not necessarily need to be performed. The predetermined processes may be other processes different from these ones.

The data server 100 may perform compression or encryption of the data segments 510 and then send them to the respective nodes 200. In that case, each of the nodes 200 may generate a replica of the compressed data segment 510 into other ones of the nodes 200. In this way, the traffic volume between the nodes 200 and the amount of memory usage associated with the replica generation can be reduced.

The data server 100 may change the data segment size dynamically. In that case, the data server 100 determines the data segment size on the basis of, for example, an average size of pieces of target information extracted at the respective nodes 200. Also in that case, the data segment size may be determined excluding target information of an abnormal size such as a log record at a time of an error.

In the first exemplary embodiment of the present invention, each of the nodes 200 uses, as a related data segment of the data segment 510 received from the data server 100, a replica of a data segment 510 which is immediately prior or subsequent to the data segment 510, but a replica of a series of two or more consecutive data segments 510 which is immediately prior or subsequent to the data segment 510 may be used. As a result, extraction of even large size target information becomes possible at each of the nodes 200.

The related data segment may be a data segment 510 other than that immediately adjacent in the original data 500, as long as the other data segment 510 is a data segment 510 which is other than that received from the data server 100 and used in a predetermined process on the data segment 510 received from the data server 100, such as, for example, another data segment 510 associated with the data segment 510 received from the data server 100 by a link.

Further, in the first exemplary embodiment of the present invention, each of the nodes 200 generates a replica of a data segment 510 received from the data server 100 into other ones of the nodes 200 according to the replica generation destination node IDs in the metadata 520, but when the node 200 can know other nodes 200 which use the data segment 510 being its processing target as a related data segment, for example, when sending of data segments 510 from the data server 100 to all nodes 200 is performed by the round-robin method, the node 200 may generate a replica of the data segment 510 received from the data server 100 into other nodes 200 without using the metadata 520.

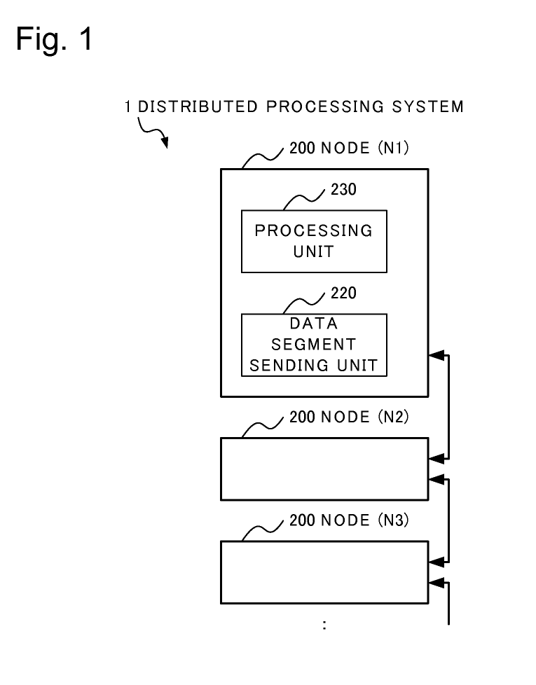

Next, a characteristic configuration of the first exemplary embodiment of the present invention will be described. FIG. 1 is a block diagram showing a characteristic configuration of the first exemplary embodiment of the present invention.

A distributed processing system (an information processing system) 1 includes nodes (processing devices) 200. Each of the nodes 200 includes a data segment sending unit (sending unit) 220 and a processing unit 230. The data segment sending unit 220 sends a data segment 510 being a processing target of the node 200 among a plurality of data segments 510, to another node 200 having a possibility of using the data segment 510 as a related data segment. The processing unit 230 performs a predetermined process on the data segment 510 by using the data segment 510 and a related data segment, of the data segment 510, which is received from another node 200.

Next, the effect of the first exemplary embodiment of the present invention will be described.

According to the first exemplary embodiment of the present invention, it becomes possible, in a system of performing distributed processing on a plurality of data segments at a plurality of nodes 200, to reduce the processing load on the system. It is because the data segment sending unit 220 of each of the nodes 200 sends a data segment 510 being its processing target, among the plurality of data segments, to nodes 200 having a possibility of using the data segment 510 as a related data segment, and the processing unit 230 of each of the nodes 200 performs a predetermined process on a data segment 510 being its processing target, using the data segment 510 and a related data segment, of the data segment 510, received from another node 200. For this reason, each of the nodes 200 does not need to search for another node 200 holding a related data segment of a data segment 510 being its processing target, and consequently, the processing load on each of the nodes 200 is reduced.

According to the first exemplary embodiment of the present invention, it also becomes possible to reduce the processing load on the data server 100. It is because the data server 100 divides original data 500 into data segments of a predetermined size, and each of the nodes 200 extracts target information from a data segment 510 being its processing target and a related data segment of the data segment 510. For this reason, the data server 100 does not need to extract target information by detecting delimiters in the original data 500, and consequently, the processing load on the data server 100 is reduced. Further, because extraction of target information is performed at the nodes 200 in a parallel and distributed manner as a result of the above-described way, the processing speed of the system is improved.

### Second Exemplary Embodiment

Next, a second exemplary embodiment of the present invention will be described.

The second exemplary embodiment of the present invention is different from the first exemplary embodiment of the present invention in that a replica of part of a data segment 510 is generated instead of generating a replica of the whole of the data segment 510.

Next, a description will be given of import of original data 500 into a distributed parallel processing platform in the second exemplary embodiment of the present invention.

FIG. 11 is a diagram showing import of original data 500 into a distributed parallel processing platform in the second exemplary embodiment of the present invention.

If a data segment 510 received from the data server 100 (a data segment 510 being its processing target) includes only part of target information to be extracted, each of the nodes 200 extracts the target information by using a replica of part (the first half or the second half) of an immediately adjacent data segment of the received data segment 510. In the second exemplary embodiment of the present invention, a replica of part of an immediately adjacent data segment of the received data segment 510 is referred to as a related data segment. When having received a data segment 510 from the data server 100, each of the nodes 200 generates a replica of part (the first half or the second half) of the data segment 510 into another one of the nodes 200 which uses the part (the first half or the second half) of the data segment 510 as a related data segment.

Next, a description will be given of a configuration of a distributed processing system 1 in the second exemplary embodiment of the present invention.

The configuration of the distributed processing system 1 in the second exemplary embodiment of the present invention is the same as that in the first exemplary embodiment of the present invention (FIG. 2).

When each node 200 has received a data segment 510 from the data server 100, the data segment sending unit 220 of the node 200 generates a replica of part (the first half or the second half) of the data segment 510 into another node 200 according to metadata 520 associated with the data segment 510.

If the data segment 510 includes only part of target information to be extracted, the processing unit 230 of the node 200 extracts the target information from the data segment 510 and also from a replica of part of an immediately adjacent data segment of the data segment 510.

Next, operation of the second exemplary embodiment of the present invention will be described.

A flow chart showing processes performed by the data server 100 and by the nodes 200 in the second exemplary embodiment of the present invention is the same as that in the first exemplary embodiment of the present invention (FIG. 4).

In the step S202 in FIG. 4, the data segment sending unit 220 generates a replica of the first half of the data segment 510 into the data segment storage unit 240 of a node 200 designated by the replica generation destination node ID (preceding) in the metadata 520. Similarly, the data segment sending unit 220 generates a replica of the second half of the data segment 510 in the data segment storage unit 240 of a node 200 designated by the replica generation destination node ID (following) in the metadata 520.

For example, as shown in FIG. 11, according to the metadata 520 associated with the data segment 510 “D1” shown in FIG. 6, the data segment sending unit 220 of the node 200 “N1” generates a replica of the second half of the data segment 510 “D1” into the node 200 “N2”. Similarly, the data segment sending unit 220 of the node 200 “N2” generates a replica of the first half of the data segment 510 “D2” into the node 200 “N1” and a replica of the second half into the node 200 “N3”.

In the step S206 in FIG. 4, the processing unit 230 extracts target information from the data segment 510 and a replica of part of an immediately adjacent data segment.

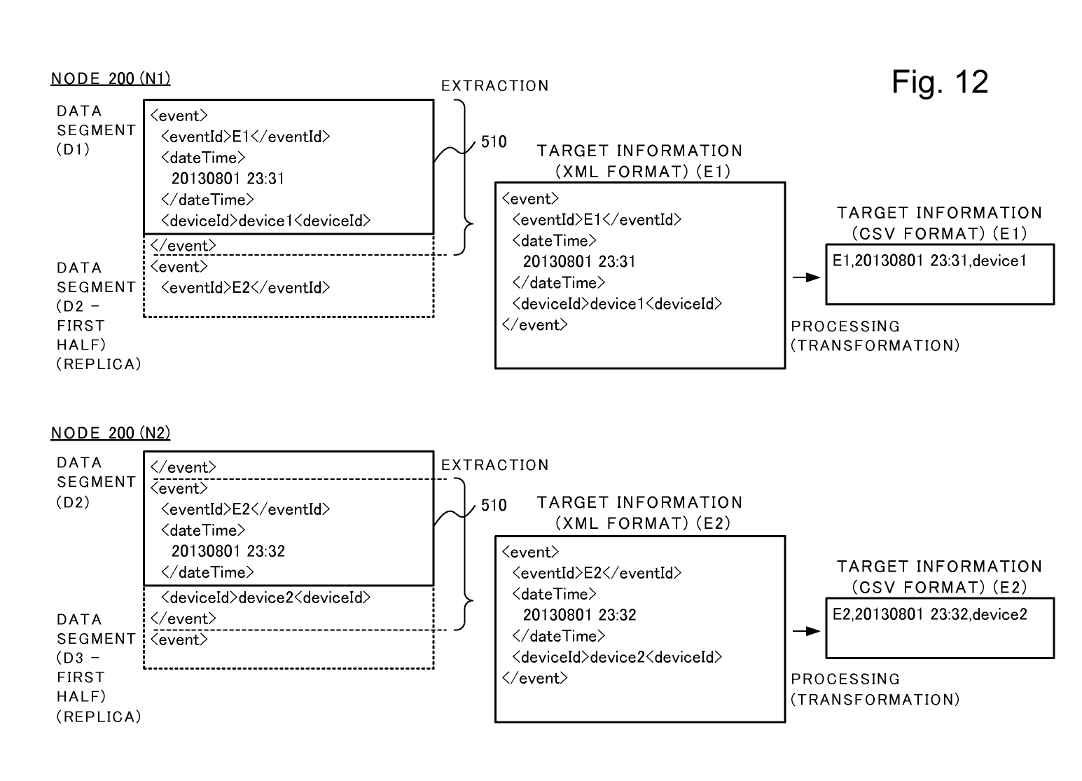

FIG. 12 is a diagram showing an example of extraction and processing of target information, in the second exemplary embodiment of the present invention.

For example, as shown in FIG. 12, the processing unit 230 of the node 200 “N1” extracts event information “E1” from the data segment 510 “D1” and from a replica of the first half of its adjacent data segment “D2”. Similarly, as shown in FIG. 12, the processing unit 230 of the node 200 “N2” extracts event information “E2” from the data segment 510 “D2” and from a replica of the first half of its adjacent data segment “D3”.

The operation of the second exemplary embodiment of the present invention is completed by executing the subsequent steps in FIG. 4.

In the second exemplary embodiment of the present invention, each node 200 generates into another node 200 a replica of the first half or the second half of a data segment 510 received from the data server 100, but the size of the replica may be larger or smaller than half as long as the replica includes a part, of the data segment 510, which is immediately adjacent to a data segment 510 being a processing target of the another node 200.

Next, the effect of the second exemplary embodiment of the present invention will be described.

According to the second exemplary embodiment of the present invention, it becomes possible to reduce the cost associated with generation of replicas of the data segments 510 and further increase the processing speed of the system, compared to the first exemplary embodiment of the present invention. It is because each node 200 generates a replica of part of a data segment 510 received from the data server 100 into another node 200. The above-described effect is achieved particularly when the data segment size and the size of target information are close to each other. It is because even when a data segment 510 does not entirely include target information, if part of an immediately adjacent data segment is available, it is highly probable that the target information can be extracted from the data segment 510 and from the adjacent data segment.

### Third Exemplary Embodiment

Next, a third exemplary embodiment of the present invention will be described.

The third exemplary embodiment of the present invention is different from the first exemplary embodiment of the present invention in that if a failure occurred in a node 200, another node 200 takes over a predetermined process from the node 200.

Next, a description will be given of a configuration of a distributed processing system 1 in the third exemplary embodiment of the present invention.

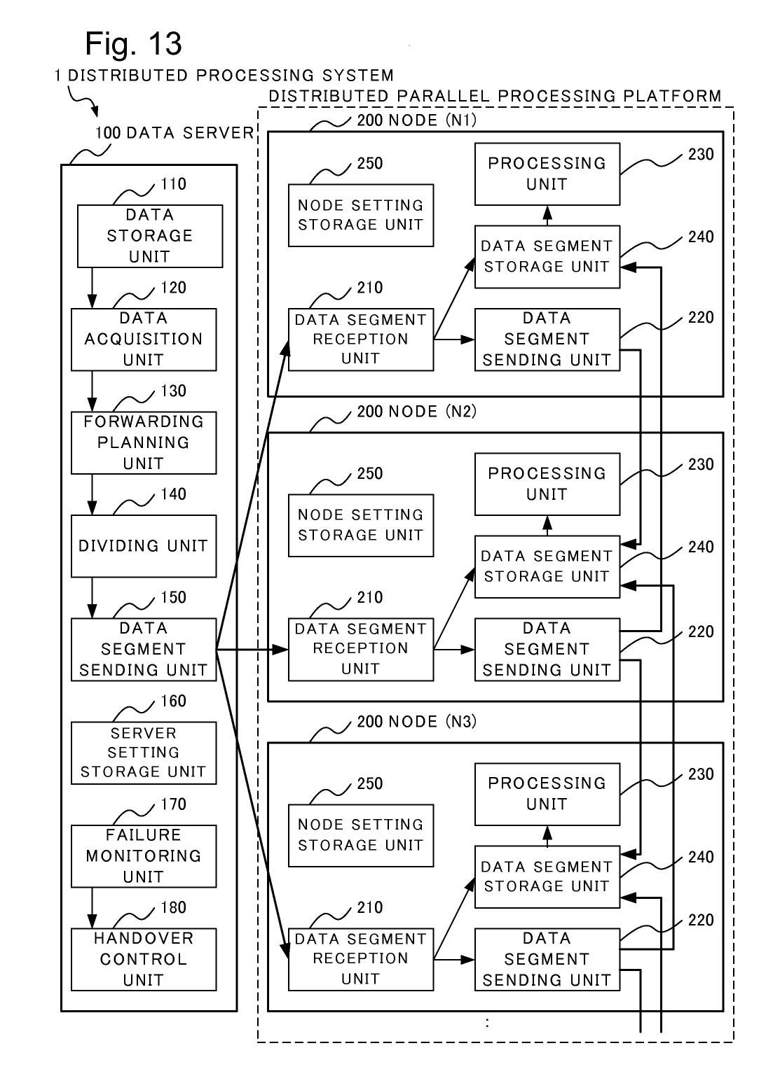

FIG. 13 is a block diagram showing a configuration of the distributed processing system 1 in the third exemplary embodiment of the present invention.

Referring to FIG. 13, a data server 100 of the distributed processing system 1 in the third exemplary embodiment of the present invention includes a failure monitoring unit 170 and a handover control unit 180 in addition to the configuration of the data server 100 of the first exemplary embodiment of the present invention.

The failure monitoring unit 170 detects a failure at a node 200.

When a failure at a node 200 is detected, the handover control unit 180 determines a node 200 (handover destination node 200) which is to take over a predetermined process from the node 200, and sends an order for handover to the determined node 200.

Using a replica of an immediately adjacent data segment of a data segment 510 (a data segment 510 being its intrinsic processing target) received by the determined node 200 from the data server 100 and also using the data segment 510 being its intrinsic processing target, the processing unit 230 of the determined node 200 performs a predetermined process on the adjacent data segment (takes over the predetermined process which was to be performed by the node 200 at which the failure has been detected).

Next, operation of the third exemplary embodiment of the present invention will be described.

The process of importing original data 500 in the third exemplary embodiment of the present invention is the same as that in the first exemplary embodiment of the present invention.

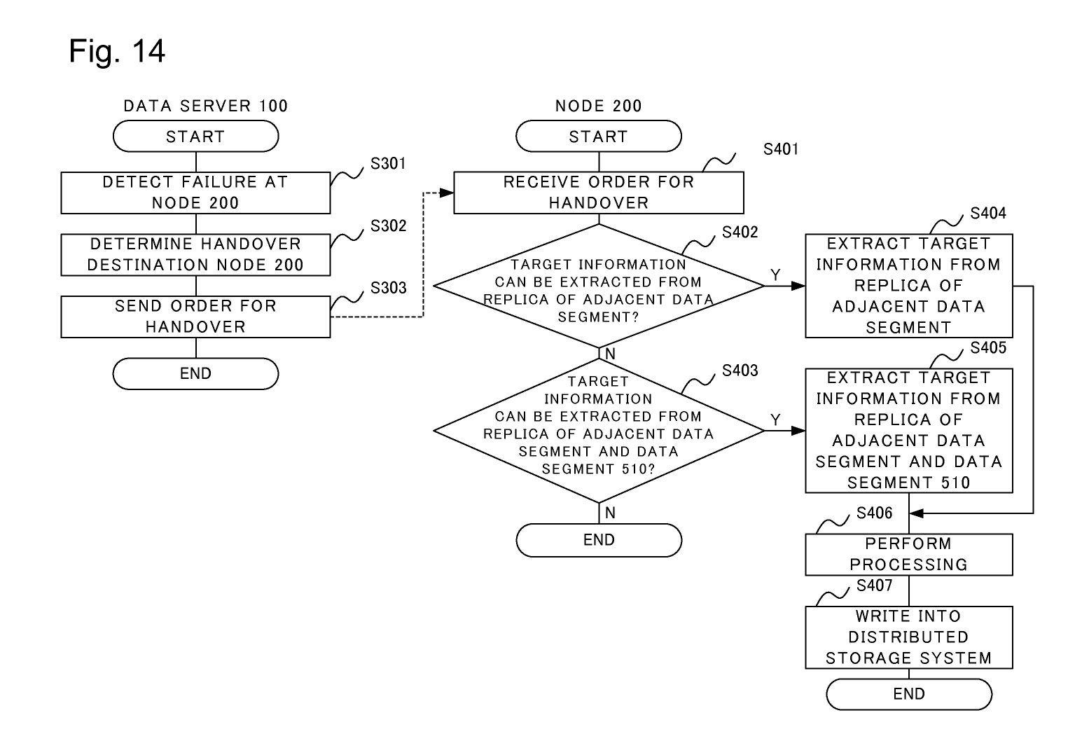

FIG. 14 is a flow chart showing a handover process in the third exemplary embodiment of the present invention.

Here, it is assumed that sending of data segments 510 from the data server 100 to the nodes 200 and generation of replicas of the data segments 510 among the nodes 200 have been already performed in the import process, and that each of the nodes 200 is executing predetermined processes (extraction of target information and its processing and writing into a distributed storage system).

First, the failure monitoring unit 170 of the data server 100 detects a failure of a node 200 (step S301). Here, the failure monitoring unit 170 detects the failure by, for example, sending and receiving a message for confirmation of life or death to and from each of the nodes 200.

For example, the failure monitoring unit 170 detects a failure of the node 200 “N1” shown in FIG. 5.

The handover control unit 180 determines a handover destination node 200 (step S302). Here, the handover control unit 180 refers to metadata 520 in the forwarding plan 131, and accordingly determines the handover destination node 200 to be a node 200 designated by the replica generation destination node ID (following) with respect to a data segment 510 being a processing target of the node 200 on which the failure has been detected.

For example, referring to metadata 520 in the forwarding plan 131 shown in FIG. 8, the handover control unit 180 determines the handover destination node 200 to be the node 200 “N2” which is the replica generation destination node with respect to the data segment 510 “D1” being a processing target of the node 200 “N1”.

Then, the handover control unit 180 sends an order for handover to the handover destination node 200 (step S303). Here, the order for handover includes the data segment ID of a data segment 510 to be handed over and the related data segment ID (following) with respect to the data segment 510.

For example, the handover control unit 180 sends an order for handover including the data segment ID “D1” and the related data segment ID (following) “D2”, to the node 200 “N2”.

The processing unit 230 of the handover destination node 200 receives the order for handover (step S401).

Then, the processing unit 230 acquires, from the data segment storage unit 240 in the same node, a replica of the data segment 510 designated by the data segment ID included in the order for handover, that is, a replica of the preceding-side adjacent data segment of a data segment 510 being its intrinsic processing target. The processing unit 230 determines whether or not target information can be extracted from the replica of the adjacent data segment (step S402). Here, if the replica of the adjacent data segment includes both a delimiter representing the start point and a delimiter representing the end point paired with the start point, the processing unit 230 determines that target information can be extracted. If the replica of the adjacent data segment includes a delimiter representing the start point but not a delimiter representing the end point paired with the start point, the processing unit 230 determines that target information cannot be extracted.

When it has determined extraction of target information to be possible in the step S402 (Y at the step S402), the processing unit 230 extracts target information from the replica of the adjacent data segment (step S404).

When it has determined extraction of target information to be impossible in the step S402 (N at the step S402), the processing unit 230 acquires a data segment 510 designated by the related data segment ID (following) included in the order for handover, that is, the data segment 510 being its intrinsic processing target, from the data segment storage unit 240.

Then, the processing unit 230 determines whether or not target information can be extracted from the replica of the adjacent data segment and the data segment 510 being its intrinsic processing target (step S403). Here, if the data segment 510 being its intrinsic processing target includes a delimiter representing the end point paired with the start point included in the replica of the adjacent data segment, the processing unit 230 determines that target information can be extracted.

When it has determined extraction of target information to be possible in the step S403 (Y at the step S403), the processing unit 230 extracts target information from the replica of the adjacent data segment and the data segment 510 being its intrinsic processing target (step S405).

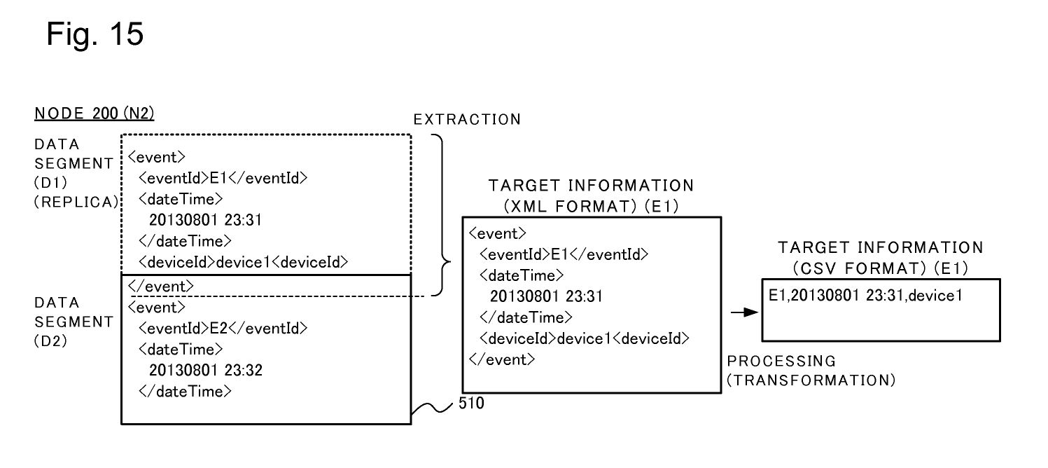

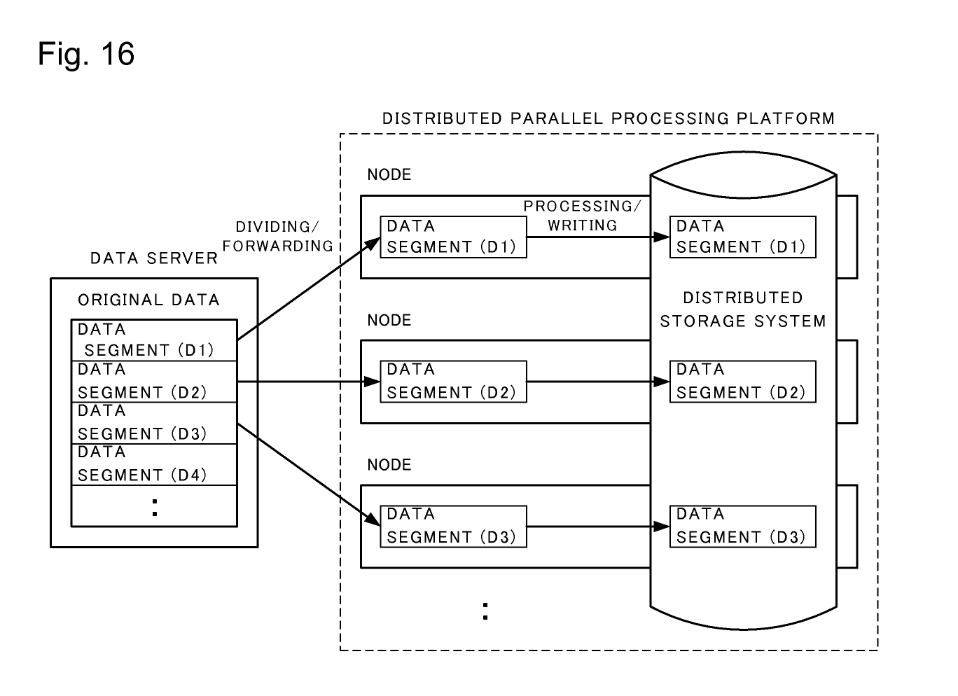

FIG. 15 is a diagram showing an example of extraction and processing of target information in the handover process in the third exemplary embodiment of the present invention.

For example, as shown in FIG. 15, the processing unit 230 of the node 200 “N2” extracts event information “E1” from the replica of the adjacent data segment “D1” and the data segment 510 “D2”.

Subsequently, the processing unit 230 performs processing of the extracted target information and then writing it into the distributed storage system in the same way as in the steps S207 and S208 (steps S406 and S407).

With those steps, the operation of the third exemplary embodiment of the present invention is completed.

In the third exemplary embodiment of the present invention, the failure monitoring unit 170 of the data server 100 detects a failure at a node 200, and then the handover control unit 180 sends an order for handover to a handover destination node 200, but each node 200 may detect a failure at another node 200 to be taken over and then take over a predetermined process from the node 200. In that case, when a node 200 has detected a failure at another node 200 designated by the replica generation destination node ID (preceding) in the metadata 520 it holds, the node 200 having detected the failure performs a predetermined process on the preceding-side adjacent data segment, of the data segment 510 being its intrinsic processing target, which is designated by the related data segment ID (preceding), using a replica of the adjacent data segment and the data segment 510 being its intrinsic processing target, both stored in the node 200.

The data server 100 may detect loss at a node 200 of a data segment 510 being a processing target of the node 200, instead of detecting a failure of a node 200, and a handover destination node 200 takes over a predetermined process from the node 200 having lost the data segment 510.

Next, the effect of the third exemplary embodiment of the present invention will be described.

According to the third exemplary embodiment of the present invention, even when a failure or loss of a data segment 510 occurs at any one of the plurality of nodes 200, the predetermined process can be kept being performed. It is because if a failure or loss of a data segment 510 occurs at a node 200, another node 200 takes over a predetermined process to be performed on the data segment 510 by using a replica of an adjacent data segment, of a data segment 510 being its intrinsic processing target, which was previously received from the node 200 of the failure or loss of a data segment 510 and is equal to the lost data segment 510, and also using the data segment 510 being its intrinsic processing target. For this reason, when a failure or loss of a data segment 510 has occurred at a node 200, a handover process can be performed without the need of the data server 100 sending again the lost data segment 510 to a handover destination node. Accordingly, it becomes possible to reduce the load on the data server 100 and increase the speed of the handover process. Further, because the metadata 520 includes information about a destination for sending of a replica of a data segment 510 and about an adjacent data segment of the data segment 510, the data server 100 can easily perform determination of a handover destination node and sending an order for handover by referring to the metadata 520.

An exemplary advantage according to the present invention is that, in a system of performing distributed processing of a plurality of data segments at a plurality of nodes, the processing load on the system can be reduced.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing system comprising processing devices, the processing devices each including:
a sending unit which sends a data segment being a processing target of the processing device among a plurality of data segments, to another processing device having a possibility of using the data segment as a related data segment; and
a processing unit which performs a predetermined process on the data segment by using the data segment and a related data segment, of the data segment, which is received from another processing device.

2. The information processing system according to claim 1, wherein
the related data segment of the data segment is a data segment immediately adjacent to the data segment in terms of arrangement in the plurality of data segments, and
the sending unit sends the data segment to another processing device which uses a data segment immediately adjacent to the data segment as a processing target.

3. The information processing system according to claim 1, wherein
the related data segment of the data segment is part of a data segment immediately adjacent to the data segment in terms of arrangement in the plurality of data segments, and
the sending unit sends, to another processing device which uses a data segment immediately adjacent to the data segment as a processing target, part of the data segment immediately adjacent to the data segment used as a processing target by the another processing device.

4. The information processing system according to claim 1, wherein
the predetermined process includes extraction of target information which is at least partly included in the data segment, from the data segment and a related data segment which includes the remaining part of the target information.

5. The information processing system according to claim 1, wherein
when a failure at the another processing device is detected, the processing unit performs the predetermined process on the related data segment received from the another processing device, using the related data segment and the data segment.

6. The information processing system according to claim 1, further comprising
a control device which divides original data into the plurality of data segments and sends the plurality of data segments to respective ones of the plurality of processing devices as the data segment being a processing target.

7. The information processing system according to claim 6, wherein
the control device divides the original data into data segments of a predetermined size.

8. The information processing system according to claim 7, wherein
the predetermined size is determined on the basis of the size of the target information.

9. The information processing system according to claim 6, wherein
the control device sends, to the processing device, related device information which designates an identifier of another processing device having a possibility of using the data segment being the processing target of the processing device as a related data segment, and
the sending unit of the processing device sends the data segment to another processing device designated by the related device information.

10. A distributed processing method for information processing system including processing devices comprises:
sending a data segment being a processing target of the processing device among a plurality of data segments, to another processing device having a possibility of using the data segment as a related data segment, in each of the processing devices; and
performing a predetermined process on the data segment by using the data segment and a related data segment, of the data segment, which is received from another processing device, in each of the processing devices.

11. The distributed processing method according to claim 10, wherein
the related data segment of the data segment is a data segment immediately adjacent to the data segment in terms of arrangement in the plurality of data segments, and
the sending sends the data segment to another processing device which uses a data segment immediately adjacent to the data segment as a processing target.

12. The distributed processing method according to claim 10, wherein
the related data segment of the data segment is part of a data segment immediately adjacent to the data segment in terms of arrangement in the plurality of data segments, and
the sending sends, to another processing device which uses a data segment immediately adjacent to the data segment as a processing target, part of the data segment immediately adjacent to the data segment used as a processing target by the another processing device.

13. The distributed processing method according to claim 10, wherein
the predetermined process includes extraction of target information which is at least partly included in the data segment, from the data segment and a related data segment which includes the remaining part of the target information.

14. The distributed processing method according to claim 10, wherein
when a failure at the another processing device is detected, performing the predetermined process on the related data segment received from the another processing device, using the related data segment and the data segment, in each of the processing devices.

15. The distributed processing method according to claim 10, further comprising
dividing original data into the plurality of data segments and sending the plurality of data segments to respective ones of the plurality of processing devices as the data segment being a processing target, in a control device.

16. The distributed processing method according to claim 15, wherein
the dividing divides the original data into data segments of a predetermined size.

17. The distributed processing method according to claim 16, wherein
the predetermined size is determined on the basis of the size of the target information.

18. The distributed processing method according to claim 15, further comprising sending, to the processing device, related device information which designates an identifier of another processing device having a possibility of using the data segment being the processing target of the processing device as a related data segment, in the control device, wherein
the sending in each of the processing devices sends the data segment to another processing device designated by the related device information.

19. A non-transitory computer readable storage medium recording thereon a program, causing a computer for each of the processing devices to function as:
a sending unit which sends a data segment being a processing target of the processing device among a plurality of data segments, to another processing device having a possibility of using the data segment as a related data segment; and
a processing unit which performs a predetermined process on the data segment by using the data segment and a related data segment, of the data segment, which is received from another processing device.

20. An information processing system comprising processing devices, the processing devices each including:
a sending means for sending a data segment being a processing target of the processing device among a plurality of data segments, to another processing device having a possibility of using the data segment as a related data segment; and
a processing means for performing a predetermined process on the data segment by using the data segment and a related data segment, of the data segment, which is received from another processing device.
